(19) United States
(12) Patent Application Publication
(10) Pub. No.: US 2022/0036185 A1
(43) Pub. Date: Feb. 3, 2022

(54) TECHNIQUES FOR ADAPTING NEURAL NETWORKS TO DEVICES

(71) Applicant: Lightmatter, Inc., Boston, MA (US)

(72) Inventors: Nicholas Dronen, Newton, MA (US); Tomo Lazovich, Cambridge, MA (US); Ayon Basumallik, Framingham, MA (US); Darius Bunandar, Boston, MA (US)

(73) Assignee: Lightmatter, Inc., Boston, MA (US)

(21) Appl. No.: 17/390,764

(22) Filed: Jul. 30, 2021

Related U.S. Application Data
(60) Provisional application No. 63/059,934, filed on Jul. 31, 2020.

(51) Int. Cl. G06N 3/08; G06N 3/067; G06N 3/063

(52) U.S. Cl. CPC G06N 3/08; G06N 3/0635; G06N 3/0675

(57) ABSTRACT

A training system for training a machine learning model such as a neural network may have a different configuration and/or hardware components than a target device that employs the trained neural network. For example, the training system may use a higher precision format to represent neural network parameters than the target device. In another example, the target device may use analog and digital processing hardware to compute an output of the neural network whereas the training system may have used only digital processing hardware to train the neural network. The difference in configuration and/or hardware components of the target device may introduce quantization error into parameters of the neural network, and thus affect performance of the neural network on the target device. Described herein is a training system that trains a neural network for use on a target device that reduces loss in performance resulting from quantization error.

### RELATED APPLICATIONS

This application claims the benefit under 35 U.S.C. 119(e) of U.S. Provisional Pat. App. Ser. No. 63/059,934, filed under Attorney Docket No. L0858.70031US00 and entitled “ADAPTING NEURAL NETWORKS TO ANALOG PROCESSORS BY TRAINING WITH NOISE”, which is hereby incorporated herein by reference in its entirety.

### FIELD

This application relates generally to techniques for adapting a neural network being trained on one system for use on a target device. The techniques reduce degradation in performance of the neural network resulting from quantization error when employed by the target device. The techniques involve training the neural network by injecting noise into layer outputs of the neural network during training.

### BACKGROUND

A neural network may include a sequence of layers. A layer may consist of a multiplication operation performed between weights of the layer and inputs to the layer. A layer may further include a non-linear function (e.g., sigmoid) applied element-wise to a result of the multiplication operation. A layer between an input and output layer of a neural network may be referred to as an interior layer. A neural network may have one or more interior layers. A computing device may determine an output of the neural network for an input by using the sequence of layers of the neural network to determine the output.

### SUMMARY

A system used to train a neural network (“training system”) may have a different configuration and/or hardware components than a target device that employs the trained neural network. For example, the training system may use a higher precision format to represent neural network parameters (e.g., weights) than the target device. In another example, the target device may use analog and digital processing hardware to compute an output of the neural network whereas the training system may have used only digital processing hardware to train the neural network. The difference in configuration and/or hardware components of the target device may introduce quantization error into parameters of the neural network, and thus affect performance of the neural network on the target device. Described herein is a training system that trains a neural network for use on a target device that reduces loss in performance resulting from quantization error.

According to some embodiments, a method of training a neural network for use on a device is provided. The neural network comprises a plurality of layers and a plurality of parameters. The method comprises: using a processor to perform: obtaining training data comprising a plurality of sample inputs; training the neural network using the training data, the training comprising, for each of at least some of the plurality of sample inputs: determining, using the sample input, a layer output of at least one layer of the plurality of layers of the neural network; obtaining a noise sample from a quantization noise model for the device; injecting the noise sample into the layer output; determining an output of the neural network for the sample input using the layer output injected with the noise sample; and updating the plurality of parameters of the neural network using the output.

According to some embodiments, a system for training a neural network for use on a device separate from the system is provided. The neural network comprises a plurality of layers and a plurality of parameters. The system comprises: a processor; and a non-transitory computer-readable storage medium storing instructions that, when executed by the processor, cause the processor to: obtain training data comprising a plurality of sample inputs; train the neural network using the training data, the training comprising, for each of at least some of the plurality of sample inputs: determining, using the sample input, a layer output of at least one layer of the plurality of layers of the neural network; obtaining a noise sample from a quantization noise model for the device; injecting the noise sample into the layer output; determining an output of the neural network for the sample input using the layer output injected with the noise sample; and updating the plurality of parameters of the neural network using the output.

According to some embodiments, a non-transitory computer-readable medium storing instructions is provided. The instructions, when executed by a processor, cause the processor to perform: obtaining training data comprising a plurality of sample inputs; training a neural network using training data, the neural network comprising a plurality of layers and a plurality of parameters, the training comprising, for each of at least some of the plurality of sample inputs: determining, using the sample input, a layer output of at least one layer of the plurality of layers of the neural network; obtaining a noise sample from a quantization noise model for the device; injecting the noise sample into the layer output; determining an output of the neural network for the sample input using the layer output injected with the noise sample; and updating the plurality of parameters of the neural network using the output.

### BRIEF DESCRIPTION OF THE DRAWINGS

Various aspects and embodiments will be described herein with reference to the following figures. It should be appreciated that the figures are not necessarily drawn to scale. Items appearing in multiple figures are indicated by the same or a similar reference number in all the figures in which they appear.

FIG. 1 illustrates a block diagram of a system in which some embodiments of the technology described herein may be implemented.

FIG. 2 illustrates an example environment in which some embodiments of the technology described herein may be implemented.

FIG. 3 illustrates an example process for training a neural network, according to some embodiments of the technology described herein.

FIG. 4A illustrates an example sequence of layers of a neural network, according to some embodiments of the technology described herein.

FIG. 4B illustrates an example of noise injection into a layer output of a layer of the neural network of FIG. 4A, according to some embodiments of the technology described herein.

FIG. 5 illustrates an example process for generating a quantization noise model for a device, according to some embodiments of the technology described herein.

FIG. 6 illustrates a diagram depicting generation of a quantization noise model for a target device, according to some embodiments of the technology described herein.

FIG. 7 illustrates an example processor, according to some embodiments of the technology described herein.

FIG. 8 illustrates an example process for determining an output of a neural network by a device, according to some embodiments of the technology described herein.

FIG. 9A illustrates an example matrix multiplication operation that is to be performed to determine a layer output, according to some embodiments of the technology described herein.

FIG. 9B illustrates an example tiling to be used to perform the matrix multiplication operation of FIG. 9A, according to some embodiments of the technology described herein.

FIG. 10 illustrates a table indicating performance of a neural network on a device relative to a training system without using some embodiments of the technology described herein.

FIG. 11 illustrates a table indicating performance of a neural network on a device relative to a training system, according to some embodiments of the technology described herein.

FIG. 12 illustrates a set of histograms of differences between training system layer outputs and device layer outputs of a neural network for different batches of data, according to some embodiments of the technology described herein.

FIG. 13 illustrates a graph depicting performance of an example neural network on a target device relative to a training system, according to some embodiments of the technology described herein.

FIG. 14 illustrates a graph depicting performance of an example neural network on a target device relative to a training system, according to some embodiments of the technology described herein.

FIG. 15 shows a block diagram of an example computer system that may be used to implement some embodiments of the technology described herein.

### DETAILED DESCRIPTION

Described herein are techniques of adapting a neural network to a device. The techniques mitigate loss in performance of a trained neural network on the device due to quantization error. A neural network may be trained using one computing device (“training system”) and subsequently deployed for use on another computing device (“target device”). The target device may have a different configuration and/or different hardware components than the training system. For example, the target device may use a lower precision format (e.g., a lower bit-width) to represent neural network parameters. As another example, the target device may include both analog and digital components, and an analog-to-digital converter (ADC). The different configuration and/or hardware components in the target device may result in quantization of neural network parameters and/or values computed using the neural network parameters. The neural network may perform worse on the target device than on the training system as a result of error caused by the quantization. For example, the target device's use of a lower precision (e.g., bit-width) to represent neural network parameter values than a precision used by the training system may introduce quantization error into computations involving the neural network. As another example, noise from an ADC of the target device may introduce quantization error into computations involving the neural network. The quantization error may cause layer outputs of a neural network determined by the target device to deviate from those determined by the training system, and thus reduce performance of the neural network on the target device.

Some conventional techniques mitigate loss in performance due to quantization error by increasing the precision used by the target device. For example, the bit-width used by the target device may be increased and/or a floating point format may be used to represent parameter values instead of a fixed point format. These conventional techniques, however, increase power consumption and/or area of digital circuitry in the target device and may reduce computational efficiency in using the neural network. Other conventional techniques may limit performance loss due to quantization by limiting the target device to digital components in order to eliminate quantization error resulting from ADC noise. However, these conventional techniques prevent the target device from taking advantage of efficiency improvements achieved by performing certain computations (e.g., multiplication) in analog.

The inventors have recognized the above-described shortcomings of conventional techniques in mitigating performance loss due to quantization error. Accordingly, the inventors have developed techniques of training a neural network that mitigate performance loss due to quantization error. The techniques incorporate noise that simulates quantization error of the target device into training of the neural network. The parameters of a neural network learned through the techniques are thus more robust to quantization error on the target device. Unlike conventional techniques, the techniques described herein mitigate performance loss without requiring an increase in precision of the target device (e.g., an increased bit-width). The techniques do not increase power consumption and/or area of digital circuitry in the target device nor do they decrease computational efficiency in using the neural network. Moreover, the techniques do not limit the target device to digital components, and thus allow the target device to take advantage of efficiency improvements provided by analog components.

In some embodiments, a training system trains a neural network using a quantization noise model for a device. During training, the training system obtains noise samples from the quantization noise model and injects the noise samples into outputs of one or more layers of the neural network (“layer outputs”). The training system may perform an iterative training technique to train the neural network using training data consisting of sample inputs. For each sample input, the training system determines, using the sample input, one or more layer outputs of the neural network. The system obtains noise sample(s) from the quantization noise model for the device and injects the noise sample(s) into the layer output(s). The system determines a final output of the neural network (e.g., an output of the last layer of the neural network) for the sample input using the layer output(s) injected with the noise sample(s). The system then updates parameters of the neural network using the final output (e.g., based on a difference between the final output and a label associated with the sample input).

Some embodiments described herein address all the above-described issues that the inventors have recognized with conventional techniques of mitigating performance loss due to quantization error. However, it should be appreciated that not every embodiment described herein addresses every one of these issues. It should also be appreciated that embodiments of the technology described herein may be used for purposes other than addressing the above-discussed issues of conventional techniques.

Example embodiments are described herein using a neural network as an example machine learning model. However, some embodiments may adapt other machine learning models to a target device. For example, some embodiments may adapt a support vector machine (SVM), a logistic regression model, a linear regression model, or other suitable machine learning model to a target device. The system may be configured to obtain training data comprising a plurality of sample inputs. The system may be configured to train a machine learning model using the training data. The system may be configured to, for each of at least some of the plurality of sample inputs, determine, using the sample input, an intermediate output or final output of the machine learning model. The system may be configured to obtain a noise sample from a quantization noise model for the device and inject the noise sample into the intermediate output or the final output. The system may be configured to update the parameter(s) of the machine learning model using the final output injected with the noise sample or a final output determined using the intermediate output injected with the noise sample.

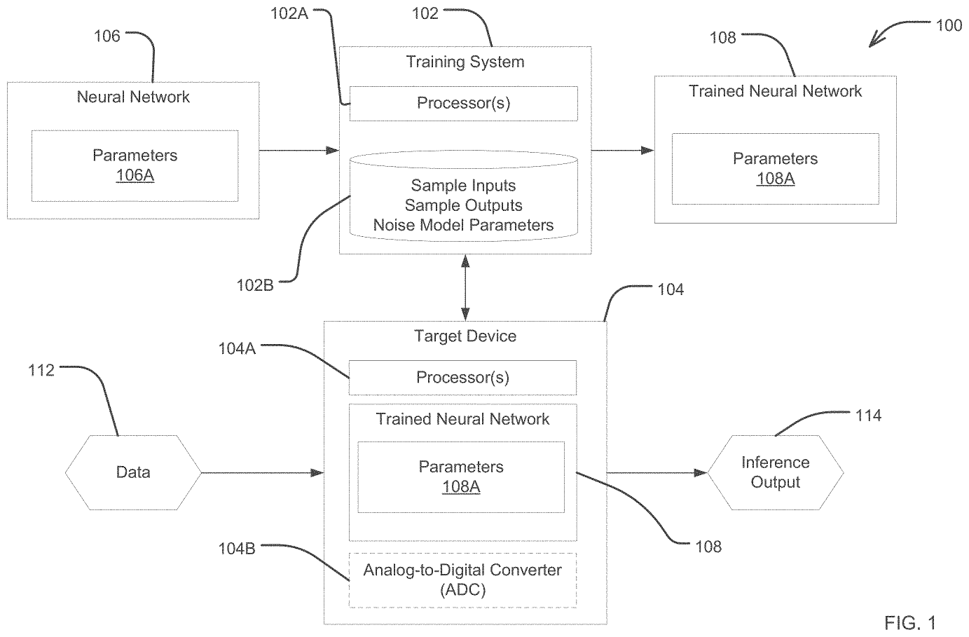

FIG. 1 illustrates a block diagram of a system 100 in which some embodiments of the technology described herein may be implemented. The system 100 includes a training system 102 and a target device 104.

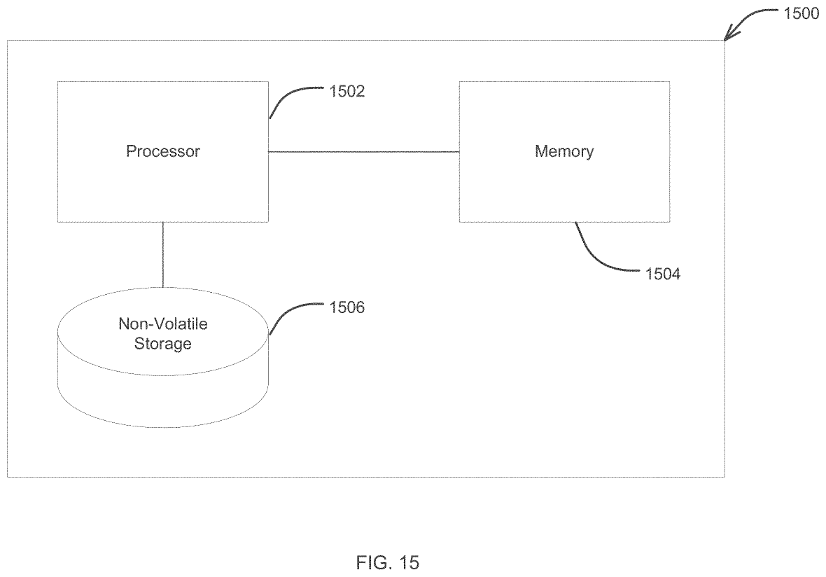

The training system 102 may be any suitable computing device. In some embodiments, the training system 102 may be a computing device as described herein with reference to FIG. 15. In some embodiments, the training system 102 may be a server. In some embodiments, the training system 102 may be a desktop computer. In some embodiments, the training system 102 may be a cloud based computing system. In some embodiments, the training system 102 may be a mobile computing device (e.g., a laptop, smartphone, tablet, or other mobile device).

As shown in FIG. 1, the training system 102 includes a processor 102A. The processor 102A may be a photonics processor, microcontroller, microprocessor, embedded processor, digital signals processing (DSP) processor, or any other suitable type of processor. In some embodiments, the processor 102A may use a first bit-width to represent numbers. The first bit-width may be 4 bits, 8 bits, 16 bits, 32 bits, 64 bits, or 128 bits. The processor 102A may be configured to process up to the first bit-width in a single instruction. Thus, the processor 102A may be configured to process up to the first bit-width in a single clock cycle. In one example, the processor 102A may be a 32-bit processor. In this example, the processor 102A may process one or more numbers represented by up to 32 bits in a single instruction. In some embodiments, the processor 102A may be configured to use a format to represent numbers. For example, the processor 102A may use floating point format to represent numbers. In another example, the processor 102A may use a fixed point format to represent numbers.

The training system 102 includes storage 102B. In some embodiments, the storage 102B may be memory of the training system 102. For example, the storage 102B may be a hard drive (e.g., solid state hard drive and/or hard disk drive) of the training system 102. In some embodiments, the storage 102B may be external to the training system 102. For example, the storage 102B may be a remote database server from which the training system 102 may obtain data. The training system 102 may be configured to access the remote database server via a network (e.g., the Internet, local area connection (LAN), or another suitable network). In some embodiments, the storage 102B may be cloud-based storage.

As shown in FIG. 1, the storage 102B stores training data for use by the training system 102 in training. The training system 102 may be configured to train the neural network 106 using the training data. The training data may include sample inputs (e.g., input data and/or sets of input features generated using the input data). The training data may include sample outputs corresponding to the sample inputs. The sample outputs may be labels corresponding to the sample inputs that represent target outputs of a model (e.g., a neural network) for use in training. For example, the sample inputs and sample outputs may be used to perform a supervised learning technique to train the neural network 106.

The storage 102B may store noise model parameters. The noise model parameters may define one or more quantization noise models for a device (e.g., target device 104) used by the training system 102 for training the neural network 106. A quantization noise model may model quantization error of a target device (e.g., target device 104). For example, the quantization noise model may model quantization error resulting from use of a lower precision (e.g., lower bit-width) by the target device than that of the processor 102A, use of a different format for representing numbers, and/or noise from an analog-to-digital converter (ADC) of the target device. In some embodiments, a quantization noise model may be defined by one or more parameters. For example, the quantization noise model may be a Gaussian distribution defined by mean and variance parameters, a uniform distribution defined by minimum and maximum values, an Irwin-Hall distribution defined by a mean and variance, or other distribution. In some embodiments, a quantization noise model may be an unspecified distribution with parameters determined from empirical observations. For example, the quantization noise model may be a distribution of differences (e.g., in a histogram) between layer outputs of a target device (e.g., target device 104) and those of the training system 102 for one or more neural networks.

The training system 102 may be configured to use the processor 102A to train the neural network 106 using training data stored in the storage 102B. In some embodiments, the training system 102 may be configured to train the neural network 106 using a supervised learning technique. For example, the training system 102 may perform gradient descent (e.g., stochastic gradient descent, batch gradient descent, mini-batch gradient descent, etc.) to learn parameters (e.g., weights and/or biases) of the neural network 106. In some embodiments, the training system 102 may be configured to train the neural network 106 using an unsupervised learning technique. For example, the training system 102 may use a clustering algorithm to train the neural network 106. In some embodiments, the training system 102 may be configured to train the neural network 106 using a semi-supervised learning technique. For example, the training system 102 may determine a set of classes using clustering, label sample inputs with the determined set of classes, and then use a supervised learning technique to train the neural network 106 using the labeled sampled input.

The neural network 106 may be any suitable neural network. For example, the neural network 106 may be a convolutional neural network (CNN), a recurrent neural network (RNN), a transformer neural network, or any other suitable type of neural network. The neural network 106 includes parameters 106A that are to be learned during training. The parameters 106A may be weights or coefficients of the neural network 106 that are learned during training. For example, the parameters 106A may be iteratively updated during training (e.g., during performance of gradient descent). In some embodiments, the parameters 106A may be randomized values. In some embodiments, the parameters 106A may be parameters 106A learned from previously performed training. For example, the neural network 106 with parameters 106A may have been obtained by training another neural network.

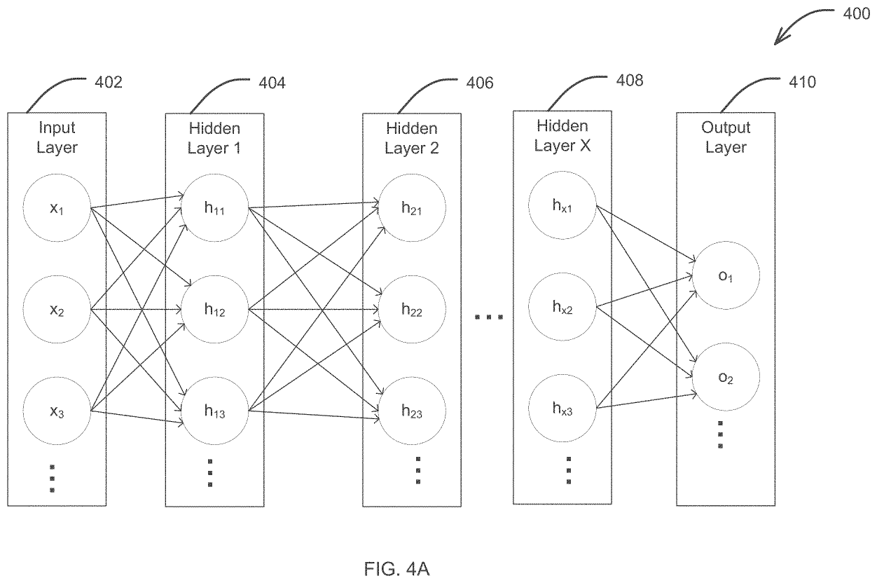

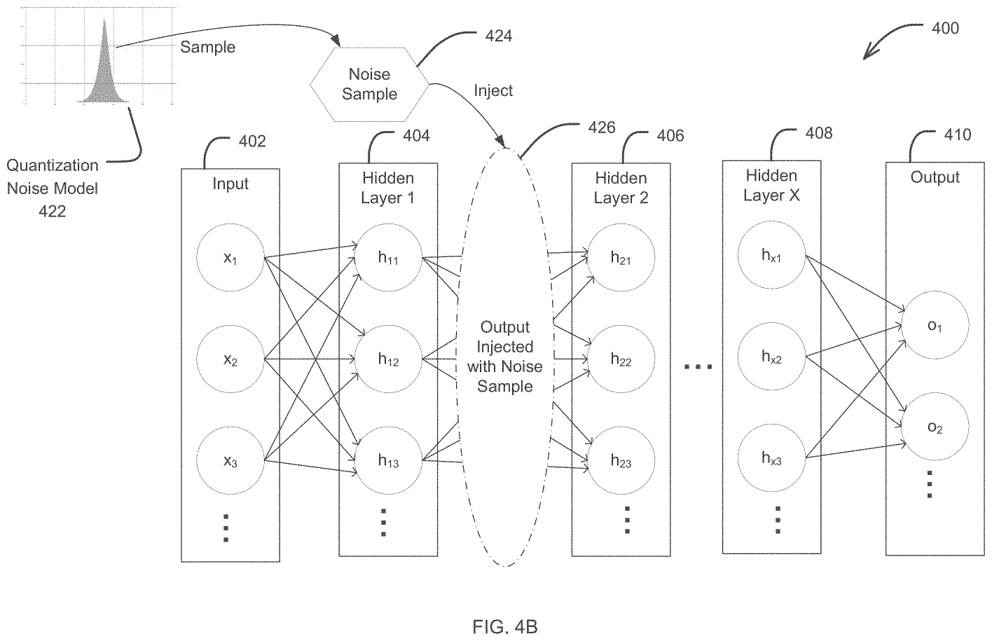

The neural network 106 may include multiple layers. FIG. 4A illustrates an example set of layers of a neural network 400, according to some embodiments of the technology described herein. As shown in FIG. 4A, the neural network 400 includes an input layer 402 that receives input [x₁, x₂, x₃, . . . ]. For example, the input may be an input set of features (e.g., an image, or vector) that the neural network 400 receives as input. The neural network 400 includes an output layer 410 that generates output [o₁, o₂, . . . ]. For example, the output may be an inference or prediction of the neural network 400 for the input received by the input layer 402. The neural network 400 includes interior layers 404, 406, 408 between the input layer 402 and the output layer 410. An interior layer may also be referred to as a “hidden layer”. As can be appreciated by the dots between hidden layer 2 406 and hidden layer X 408, the neural network 400 may have any number of hidden layers. In some embodiments, a hidden layer may include multiple nodes, each of which is connected to nodes of a previous layer. As an illustrative example, in FIG. 4A hidden layer 2 406 has nodes [h₂₁, h₂₂, h₂₃, . . . ] that have connections to nodes [h₁, h₁₂, h₁₃, . . . ] of hidden layer 1 404. Each of the connections may have a respective weight associated with it. Each node may have a value determined using weights associated with its set of connections and values of the nodes from the previous layer. For example, the value of node h₂₁ of hidden layer 2 406 may be determined by the values of nodes h₁₁, h₁₂, h₁₃ of hidden layer 1 404 and weights associated with connections between nodes h₁₁, h₁₂, h₁₃ and node h₂₁ of hidden layer 2 406. The value of node h₂₁ may be determined by multiplying values of each of nodes h₁₁, h₁₂, h₁₄ with weights associated with their respective connections to node h₂₁ and summing the products. A layer output for a layer of the neural network 400 may be the values of its respective nodes. For example, the layer output of hidden layer 2 406 may be the values of nodes [h₂₁, h₂₂, h₂₃, . . . ].

A layer of neural network 106 may be a different type of layer than those illustrated in FIG. 4A. In some embodiments, a layer of a neural network may be a convolution layer (e.g., in a convolutional neural network). The convolutional layer may include a convolution kernel that is convolved with an input to the layer to determine the layer output. The input may be an input matrix that is convolved with the kernel to generate an output matrix. The layer output may be the output matrix. In some embodiments, a layer of the neural network 106 may be a deconvolution layer. In some embodiments, a layer of the neural network 106 may be a recurrent layer that incorporates previous outputs of the layer into determining a current output.

In some embodiments, the training system 102 may be configured to incorporate noise injection into training of the neural network 106. The training system 102 may be configured to inject noise into layer outputs of the neural network 106 during training. For example, the training system 102 may perform iterative training (e.g., gradient descent) using sample inputs in which the training system 102 injects noise during at least some training iterations. In some embodiments, the training system 102 may be configured to inject noise in a training iteration by: (1) determining a layer output of at least one layer of the neural network 106; (2) obtaining a noise sample from a quantization noise model for a target device; and (3) injecting the noise sample into the layer output. The training system 102 may be configured to inject the noise sample into the layer output by combining the layer output with the noise sample. In some embodiments, the training system 102 may be configured to additively inject the noise sample into the layer output. For example, the layer output may include multiple output values and the noise sample may include multiple noise values corresponding to respective output values. The training system 102 may sum the layer output values with the corresponding noise values of the noise sample. In some embodiments, the training system 102 may be configured to multiplicatively inject the noise sample into the layer output. The training system 102 may multiply layer output values with corresponding noise values of the noise sample (e.g., using matrix element-wise multiplication).

In some embodiments, the training system 102 may be configured to determine an output of the neural network 106 for a sample input using one or more layer outputs injected with noise sample(s). The training system 102 may be configured to use a layer output injected with a noise sample as input to a subsequent layer of the neural network. An output of the neural network 106 may thus simulate an effect of quantization error modeled by a quantization noise model on the neural network 106. The training system 102 may be configured to update the parameters 106A (e.g., weights) of the neural network 106 using the determined output. For example, the training system 102 may determine a gradient of a loss function and update the parameters 106A by adjusting (e.g., increasing or decreasing) the parameters 106A by a proportion of the determined gradient. The training system 102 may then select another sample input and repeat steps of noise injection, determination of an output, and updating of the parameters 106A. In this manner the training system 102 may be configured to iteratively train neural network 106 to obtain trained neural network 108 with parameters 108A.

The training system 102 may be configured to provide the trained neural network 108 to the target device 104 for use by the target device 104. The training system 102 may be configured to provide the trained neural network 108 to the target device 104 by providing the parameters 108A to the target device 104. In some embodiments, the training system 102 may be configured to be communicatively coupled to the target device 104. For example, the training system 102 may communicate with the target device 104 through a communication network (e.g., the Internet). The training system 102 may provide the trained neural network 108 to the target device 104 through the communication network. In another example, the training system 102 may be connected to the target device 104 with a wired connection through which it may transmit the trained neural network 108 to the target device 104.

The target device 104 may be any suitable computing device. In some embodiments, the target device 104 may be a computing device as described herein with reference to FIG. 15. As an illustrative example, the target device 104 may be a mobile device (e.g., a smartphone), a camera, a sensor device, an embedded system, or any other computing device.

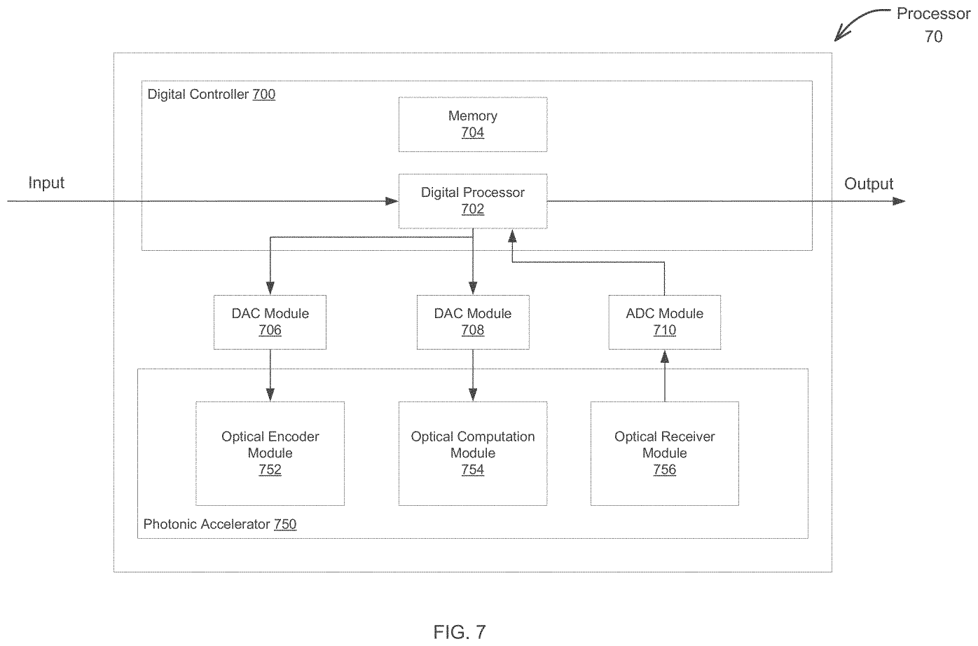

As shown in FIG. 1, the target device 104 includes one or more processors 104A. In some embodiments, the processor(s) 104A may include a digital processor, an analog processor, an optical computing processor, a photonic processor, a microcontroller, a microprocessor, an embedded processor, a digital signals processing (DSP) processor, a neural processor, and/or any other suitable type of processor. In some embodiments, the processor(s) 104A may include processor 70 described herein with reference to FIG. 7. In some embodiments, the processor 104A may use a bit-width to represent numbers. The bit-width may be 4 bits, 8 bits, 16 bits, 32 bits, or 64 bits. The processor(s) 104A may be configured to process up to the bit-width in a single instruction. Thus, the processor 104A may be configured to process up to the bit-width in a single clock cycle. In one example, the processor(s) 104A may include an 8-bit processor. In this example, the 8-bit processor may process one or more numbers represented by up to 8 bits in a single instruction. In some embodiments, a bit-width used by the processor(s) 104A may be less than a bit-width used by the processor(s) 102A of training system 102. For example, the processor(s) 104A may use a bit-width of 8 bits while the processor(s) 102A may use a bit-width of 32 bits. The difference in bit-width may introduce quantization error into computations involving the trained neural network 108.

In some embodiments, the processor(s) 104A may be configured to use a format to represent numbers. For example, the processor(s) 104A may use floating point format to represent numbers. In another example, the processor(s) 104A may use a fixed point format to represent numbers. In some embodiments, the format used by the processor(s) 104A may be different than the one used by the processor(s) 102A of the training system 102. For example, the processor(s) 102A may use a floating point format while the processor(s) 104A may use a fixed point format. The difference in format may introduce quantization error into computations involving the trained neural network 108.

As shown in FIG. 1, the target device 104 may include an analog-to-digital converter (ADC) 104B. For example, the processor(s) 104A may include a digital processor and an analog processor (e.g., a photonic processor, optical processor, or other type of analog processor). The target device 104 may transform analog signals to digital signals using the ADC 104B. In some embodiments, the target device 104 may be configured to use an analog processor to perform one or more computations. For example, the target device 104 may use the analog processor to perform multiplication operations for determining layer outputs of the neural network 108 for an input. The target device 104 may be configured to transform analog signals obtained from performing the computation(s) using the analog processor into digital signals using the ADC 104B. The ADC 104B may introduce noise into values and thus cause quantization error.

As shown in FIG. 1, the target device 104 stores the trained neural network 108 (e.g., trained by training system 102) on the target device 104. The target device 104 may be configured to store the trained neural network 108 by storing parameters 108A of the trained neural network 108. For example, the target device 104 may store the parameters 108A in memory of the target device 104. The parameters 108A may include weights (e.g., fully connected layer weights, convolution kernel weights, and/or other weights) of the neural network.

The target device 104 may be configured to use the trained neural network 108 to generate an inference output 114 for a set of input data 112. The target device 104 may be configured to generate input to the neural network 108 using the data 112. The input may be an image, matrix, vector, tensor, or any other suitable data structure. For example, the target device 104 may determine a set of one or more features and provide the set of feature(s) as input to the neural network 108 to obtain the inference output 114. As an illustrative example, the neural network 108 may be trained to enhance images input to the target device 104. In this example, the data 112 may be pixel values of an image. The target device 104 may use the pixel values of the image to generate input (e.g., an input image, input matrix, or input vector) to the neural network 108. The target device 104 may use the parameters 108A of the neural network 108 to generate an enhancement of the image. As another example, the neural network 108 may be trained to diagnose a disease. In this example, the data 112 may be diagnostic scans of a patient. The target device 104 may use the diagnostic scans of the patient to generate input to the neural network 108, and use the parameters 108A to determine a classification of whether the patient is diagnosed as having the disease or not.

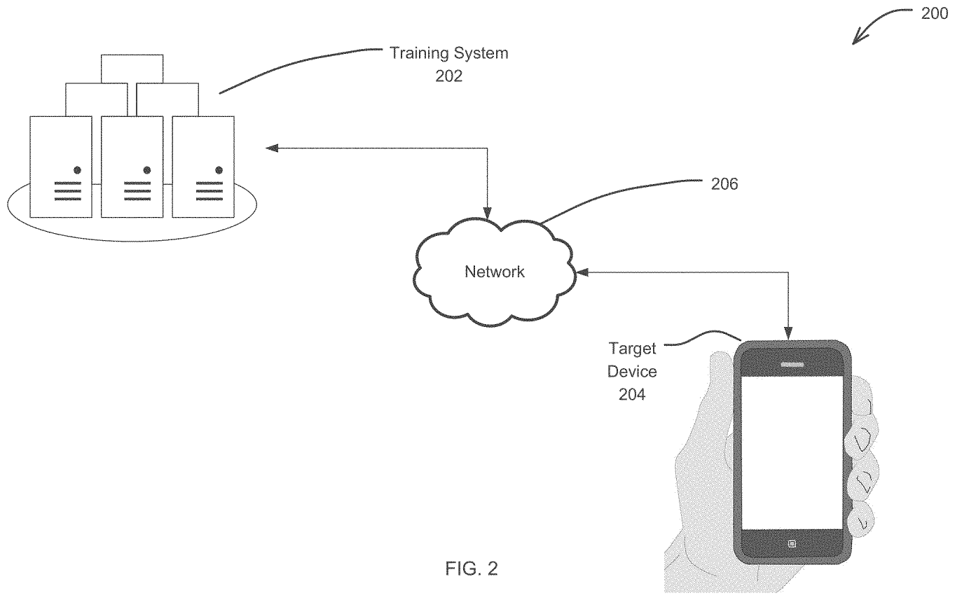

FIG. 2 illustrates an example environment 200 in which some embodiments of the technology described herein may be implemented. The environment 200 includes a training server 202, a device 204, and a network 206.

In some embodiments, the training server 202 may be a computer system for training a neural network. For example, the training system 102 described herein with reference to FIG. 1 may be implemented on the training server 202. The training server 202 may be configured to train a neural network, transmit the neural network through the network 206 to the device 204. In some embodiments, the training server 202 may be configured to train the neural network using a quantization noise model for the device 204. The training server 202 may use the quantization noise model to inject noise into layer outputs of the neural network during training.

In some embodiments, the device 204 may be target device 104 described herein with reference to FIG. 1. The device 204 may have different computational resources than those of the training server 202. For example, the device 204 may use a lower bit-width to represent numbers. In another example, the device 204 may include an analog processor to perform certain computations and an ADC to transform analog signals to digital signals. The device 204 may receive a neural network trained with a quantization noise model for the device 204 such that the neural network is robust to effects of quantization error on the device 204 (e.g., due to lower bit-width or noise from an ADC).

In some embodiments, the network 206 may be any network through which the training server 202 and the device 204 can communicate. In some embodiments, the network 206 may be the Internet, a local area network (LAN), a wide area network (WAN), a cellular network, an ad hoc network, and/or any other suitable type of network. In some embodiments, the network 206 may include a wired connection, a wireless connection, or any combination thereof.

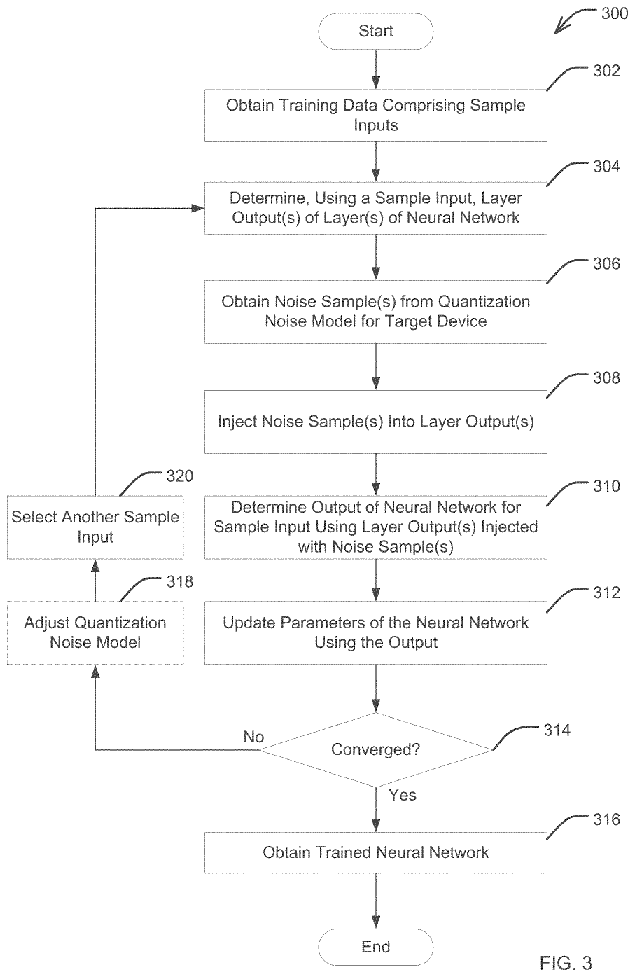

FIG. 3 illustrates an example process 300 for training a neural network, according to some embodiments of the technology described herein. Process 300 may be performed by any suitable computing device. For example, process 300 may be performed by training system 102 described herein with reference to FIG. 1.

Prior to beginning process 300, the system performing process 300 may obtain a neural network. The neural network may have parameters (e.g., weights). In some embodiments, the neural network may be a previously trained neural network. The parameters may have been learned from a previously performed training. For example, the neural network may have been previously trained by the system by performing process 300. In another example, the neural network may have been previously trained using another training technique. The system may perform process 300 to further train the previously trained neural network. For example, the system may perform process 300 to further train the neural network to be robust to quantization error that would be present on a target device (e.g., target device 104). In some embodiments, the neural network may be an untrained neural network. For example, the parameters of the neural network may be initialized to random values that need to be learned by performing process 300.

Process 300 begins at block 302, where the system performing process 300 obtains training data comprising multiple sample inputs. In some embodiments, the system may be configured to obtain the sample inputs by: (1) obtaining sets of input data; and (2) generating the sample inputs using the sets of input data. In some embodiments, a sample input may be a set of input features generated by the system. The system may be configured to preprocess input data to generate the set of input features. As an illustrative example, the input data may be an image. The system may be configured to generate a sample input for the image by: (1) obtaining pixel values of the image; and (2) storing the pixel values in a data structure to obtain the sample input. For example, the data structure may be a matrix, vector, tensor, or other type of data structure. In some embodiments, the system may be configured to preprocess input data by normalizing the input data. For example, the system may normalize pixel values based on a minimum and maximum pixel value in the image. In some embodiments, the system may be configured to preprocess input data by encoding categorical parameters (e.g., one-hot encoding the categorical parameters).

In some embodiments, the system may be configured to obtain labels for the sample inputs. The labels may be target outputs corresponding to the sample inputs to use during training (e.g., to perform a supervised learning technique). Continuing with the example of input data consisting of an input image, the system may obtain an output image corresponding to the input image. The output image may represent a target enhancement of the input image that is to be generated by the neural network. In some embodiments, the system may be configured to obtain labels comprising target classifications for respective sets of input data. For example, the input data may be diagnostic scans of patients and the labels may be disease diagnoses for the patients (e.g., determined from diagnosis by clinicians using other techniques).

In some embodiments, the system may be configured to obtain the training data by: (1) obtaining a set of sample inputs; and (2) duplicating the set of sample inputs to obtain training data including the set of sample inputs and the duplicate sample inputs. The system may be configured to train the neural network using the set of sample inputs and the duplicate sample inputs. For example, the system may divide the training data into mini-batches, and duplicate the mini-batches. The system may use the original mini-batches and the duplicates to train the neural network.

After obtaining the training data at block 302, process 300 proceeds to block 304, where the system uses a sample input of the training data to determine layer output(s) of one or more layers of the neural network. In some embodiments, the system may be configured to determine a layer output of a layer of the neural network using an input to the layer and parameters (e.g., weights) associated with the layer. For example, referring again to FIG. 4A, the system may determine an output of hidden layer 2 406 using the output from hidden layer 1 404 (e.g., values of the nodes of hidden layer 1 404), and weights associated with connections to the nodes of hidden layer 2 406. In another example, the system may determine a layer output by convolving an input matrix with a convolution kernel to obtain the layer output.

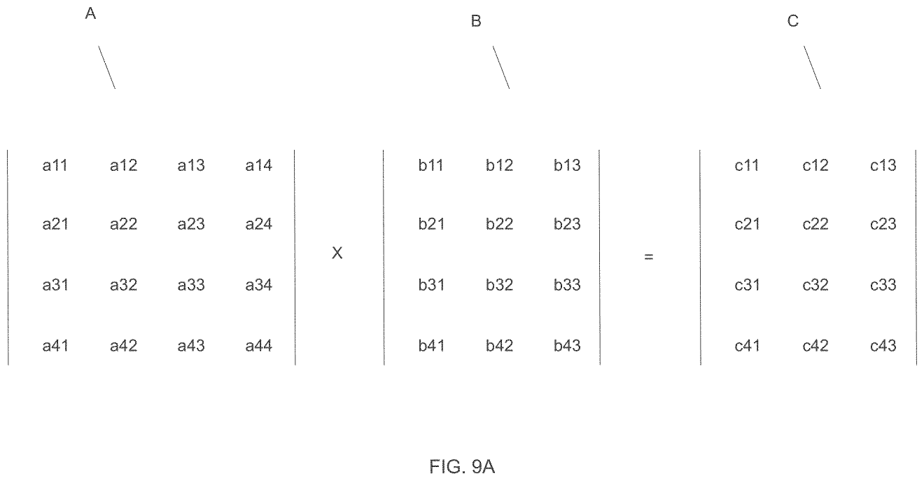

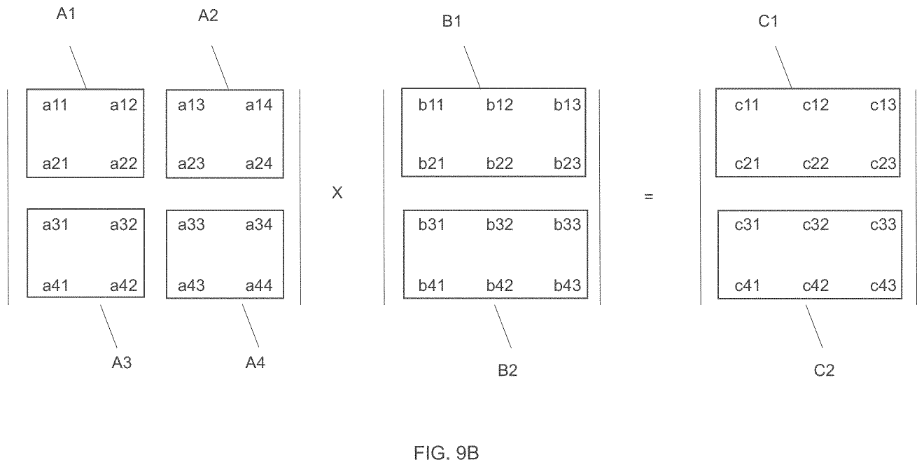

In some embodiments, the system may be configured to determine a layer output for a layer by performing computations using matrices. An input to the layer (e.g., a layer output of a previous layer or a sample input) may be organized into a matrix. The parameters (e.g., weights) of the layer may be organized into a matrix. The system may be configured to determine the layer output by performing matrix multiplication between the input matrix and the parameters matrix to generate an output matrix. For example, the output matrix may store the output of each node of the layer in a row or column of the output matrix. FIG. 9A illustrates an example matrix multiplication operation that is to be performed to determine a layer output, according to some embodiments of the technology described herein. In the example of FIG. 9A, the matrix A may store the weights of a layer, and the matrix B may be an input matrix provided to the layer. The system may perform matrix multiplication between matrix A and matrix B to obtain output matrix C. The output matrix C may be the layer output of the layer. In another example, the system may perform a convolution operation between a kernel matrix and an input matrix to obtain an output matrix.

In some embodiments, the system may be configured to determine a layer output matrix using an input matrix and a parameter matrix using tiling. Tiling may divide a matrix operation into multiple operations between smaller matrices. The system may be configured to use tiling to perform the multiplication operation in multiple passes. In each pass, the system may perform an operation over a tile of a matrix. In some embodiments, the system may perform tiling to simulate computation that would be performed on a target device. For example, a target device may use tiling due to resource constraints. As an example, the processor of the target device may not be sufficiently large to perform a multiplication between large matrices (e.g., with thousands of rows and/or columns) in one pass. Tiling may allow the target device to perform matrix operations using a smaller processor.

FIG. 9B illustrates an example tiling to be used to perform the matrix multiplication operation of FIG. 9A, according to some embodiments of the technology described herein. In FIG. 9B, the matrix A is divided into four tiles A1, A2, A3, and A4. In this example, each tile of A has two rows and two columns (though other numbers of rows and columns are also possible). Matrix B is divided into tile rows B1 and B2, and matrix C is segmented into rows C1 and C2. The row C1 and C2 are given by the following expressions:

C1=A1×B1+A2×B2 (1)

C2=A3×B1+A4×B2 (2)

In equation 1 above, the system may perform the multiplication of A1×B1 separately from the multiplication of A2×B2. The system may subsequently accumulate the results to obtain C1. Similarly, in equation 2, the system may perform the multiplication of A3×B1 separately from the multiplication of A4×B2. The system may subsequently accumulate the results to obtain C2.

Although the example of FIG. 3 is described using a sample input, in some embodiments, the system may be configured to determine the layer output(s) using multiple sample inputs. For example, the system may use mini-batches of sample inputs. The system may be configured to perform the steps at blocks 304-312 using the multiple sample inputs.

Next, process 300 proceeds to block 306, where the system obtains one or more noise samples from a quantization noise model for a target device. In some embodiments, the system may be configured to obtain a noise sample from a quantization noise model by randomly sampling the quantization noise model. For example, the quantization noise model may be a Gaussian distribution and the system may randomly sample the Gaussian distribution to obtain the noise sample. In another example, the quantization noise model may be an unspecified distribution of error values (e.g., empirically determined error values) and the system may randomly sample error values according to the distribution (e.g., based on probabilities of different error values). In some embodiments, the quantization noise model for the target device may include noise models for respective layers of the neural network. The system may be configured to obtain a noise sample for a layer by: (1) accessing a noise model for the layer; and (2) obtaining a noise sample from the noise model for the layer. In some embodiments, the quantization noise model for the target device may be a single noise model for all the layers of the neural network.

A noise sample for a layer output may include multiple values. For example, the noise sample may include a noise sample for each output value. Referring again to FIG. 9A, the noise sample may include a noise sample value for each output value in the output matrix C. In some embodiments, the noise sample may be a matrix having the same dimensions as the matrix of a layer output. For example, for a 100×100 output matrix, the noise sample may be a 100×100 matrix of noise values.

After obtaining the noise sample(s) at block 306, process 300 proceeds to block 308, where the system injects the noise sample(s) into one or more layer outputs. The system may be configured to inject a noise sample for a layer (e.g., obtained from a quantization noise model for the layer) into the corresponding layer output of the layer. In some embodiments, the system may be configured to additively inject a noise sample into a layer output. For example, a layer output matrix may be summed with a noise sample matrix to obtain a layer output injected with the noise sample. In some embodiments, the system may be configured to multiplicatively inject a noise sample into a layer output. The system may be configured to perform element-wise multiplication between a layer output matrix and a noise sample matrix to obtain a layer output injected with the noise sample.

In some embodiments, the system may be configured to inject a noise sample into a layer output per matrix. For example, the system may add a noise matrix to matrix C of FIG. 4A, or perform element-wise multiplication between the noise matrix and matrix C. In some embodiments, the system may be configured to inject a noise sample into a layer output using tiling. The noise sample may include one or more noise matrices for tiles of matrix C. The system may be configured to inject each of the noise matrices into a respective tile of matrix C. In this manner, the system may simulate tiling that may be performed by a target device that is to employ the trained neural network.

FIG. 4B illustrates an example of noise injection into a layer output of a layer of the neural network 400 of FIG. 4A, according to some embodiments of the technology described herein. As shown in FIG. 4B, the system performing process 400 obtains a noise sample 424 from a quantization noise model 422. The quantization noise model 422 may include a noise model for the output of hidden layer 1 404, or a single noise model for all the layers of the neural network 400. The system injects the noise sample 424 (e.g., additively, or multiplicatively) into the output (values from nodes h₁₁, h₁₂, h₁₃, . . . ) of the hidden layer 1 404 to obtain a layer output 426 injected with the noise sample 424. The layer output 426 injected with the noise sample 424 may subsequently be used as an input to hidden layer 2 406 (e.g., to determine the output 410).

After injecting the noise sample(s) into layer output(s) at block 308, process 300 proceeds to block 310, where the system determines an output of the neural network for the sample input using the layer output(s) injected with the noise sample(s). In some embodiments, the system may be configured to determine the output of the neural network by using the layer output(s) injected with the noise sample(s) to compute outputs of subsequent layers. For example, referring again to FIG. 4B, the layer output 426 injected with the noise sample 424 may be used to subsequently determine the layer output of hidden layer 2 406. The output 410 may thus reflect a simulated effect of quantization error on the neural network.

Next, process 300 proceeds to block 312, where the system updates parameters of the neural network using the output obtained at block 310. In some embodiments, the system may be configured to determine an update to the parameters of the neural network by determining a difference between the output and an expected output (e.g., a label from the training data). For example, the system may determine a gradient of a loss function with respect to the parameters using the difference. The loss function may be a mean square error function, quadratic loss function, L2 loss function, mean absolute error function, L1 loss function, cross entropy loss function, or any other suitable loss function. The system may be configured to update the parameters using the determined gradient. For example, the system may update the parameters by increasing or decreasing the parameters by a proportion of the gradient.

Next, process 300 proceeds to block 314, where the system determines whether the training has converged. In some embodiments, the system may be configured to determine whether the training has converged based on a loss function or gradient thereof. For example, the system may determine that the training has converged when the gradient of the loss function is less than a threshold value. In another example, the system may determine that the training has converged when the loss function is less than a threshold value. In some embodiments, the system may be configured to determine whether the training has converged by determining whether the system has performed a threshold number of iterations. For example, the system may determine that the training has converged when the system has performed a maximum number of iterations of blocks 304 to 312.

If at block 314, the system determines that the training has not converged, then process 300 proceeds to block 318, where the system adjusts the quantization noise model. In some embodiments, the system may be configured to adjust the quantization noise model such that noise is gradually introduced over multiple iterations of training. The system may be configured to update scalars applied to parameters of the quantization noise model to gradually introduce noise over iterations of training. The system may gradually increase the scalars to increase the level of noise injected during training. As an illustrative example, the quantitative noise model may be a Gaussian distribution Q-U(0,kB) which indicates a Gaussian distribution with mean 0 and standard deviation kB. In this example, the system may adjust the value of the scalar B to adjust the noise injected during training (e.g., by increasing B after each iteration to increase the noise variance). As another example, the quantitative noise model may be a uniform distribution

$$Q \text{∼} U ( - \frac{k B}{2} , \frac{k B}{2} )$$

which indicates a minimum value −kB/2 and maximum value kB/2 of the uniform distribution. The system may adjust the value of B to adjust the noise injected during training (e.g., by increasing B to increase the range of error values). In some embodiments, the system may be configured to determine the value of B using a function calculated after each iteration of training. Equations 3, 4 and 5 below illustrate example functions for determining the value of B.

$$\begin{matrix}B = {B}_{0} T & ( 3 ) \\ T ( x ) = \frac{1}{1 + {e}^{- f ( x )}} & ( 4 ) \\ f ( x ) = \frac{x - center}{\frac{center}{scale}} & ( 5 )\end{matrix}$$

In equations 3, 4 and 5 above, B₀ is an initial value of B, x is the current training iteration, center is the training iteration at which the function T(x) is at its midpoint, and scale controls the slope of the function. The variables center and scale may be set to control how the quantization noise model is adjusted after each training iteration. As the function T(x) is a sigmoidal function, it is in the range [0, 1]. The function T(x) is initialized at a low value and then increases with each iteration. This makes a variance of the quantization noise model start low and then gradually increase to a maximum value. The gradual increase in variance may allow the training to converge more efficiently.

As indicated by the dashed lines around block 318, in some embodiments, the system may proceed without adjusting the quantization noise model. For example, the system may use the quantization noise model used in one training iteration in a subsequent training iteration without modification to any parameters of the quantization noise model. As an illustrative example, the quantization noise model may be used in all training iterations with full scaling (e.g., B=1 in equation 3) for all iterations. Process 300 would proceed to block 320 without performing the act at block 318.

Next, process 300 proceeds to block 320, where the system selects another sample input from the training data. In some embodiments, the system may be configured to select the sample input randomly. After selecting the next sample input, process 300 proceeds to block 304 where the system determines layer output(s) of layer(s) of the neural network.

In some embodiments, the system may be configured to inject noise for some sample inputs of the training data and not inject noise for some sample inputs of the training data. For example, each sample input may be a mini-batch and the system may perform noise injection for some mini-batches and not perform noise injection for other mini-batches. In this example, the system may mask some of the mini-batches from noise injection. In some embodiments, the training data may include a first plurality of sample inputs and a second plurality of inputs that is a duplicate of the first plurality of sample inputs. The system may be configured to perform noise injection (e.g., as performed at block 308) for the first plurality of sample inputs and not the second plurality of inputs.

If at block 314, the system determines that the training has converged, then process 300 proceeds to block 316, where the system obtains a trained neural network (e.g., trained neural network 108 of FIG. 1). The system may be configured to store parameters of the trained neural network. In some embodiments, the system may be configured to provide the trained neural network to a target device (e.g., target device 104). The system may be configured to provide the trained neural network to the target device by transmitting the trained parameters to the target device. The target device may be configured to use the trained neural network for inference and/or prediction using input data received by the target device.

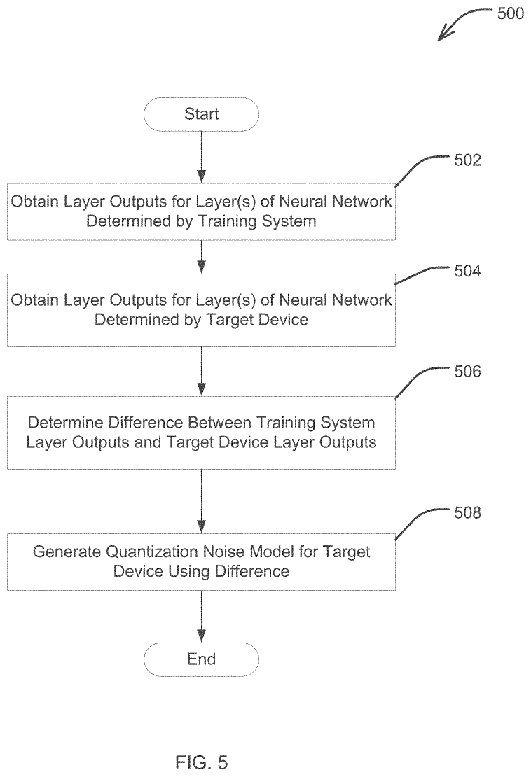

FIG. 5 illustrates an example process 500 for generating a quantization noise model for a device, according to some embodiments of the technology described herein. Process 500 may be performed by any suitable computing device. For example, process 500 may be performed by training system 102 described herein with reference to FIG. 5.

Process 500 begins at block 502, where the system obtains layer outputs of one or more layers of a neural network determined by a training system. The layer outputs determined by the training system may also be referred to as “training system layer outputs”. In some embodiments, the neural network may be obtained by performing training using training data. The neural network may be obtained by performing training without injection of noise. In some embodiments, the system performing process 500 may be the training system, and the system may be configured to determine outputs of the neural network by: (1) obtaining sample inputs; and (2) using parameters of the neural network to determine layer outputs of the layer(s) of the trained neural network. For example, the system may use parameters (e.g., weights, kernel, etc.) of each of the layer(s) to determine a layer output. The system may be configured to store the layer outputs of the layer(s) of the neural network. In some embodiments, the system performing process 500 may be separate from the training system. The system may be configured to receive layer outputs determined by the training system or another device that obtained the layer outputs from the training system. For example, the system may receive the layer outputs in a data transmission through a communication network (e.g., the Internet).

Next, process 500 proceeds to block 504, where the system obtains layer outputs of the layer(s) of the neural network determined by a target device. The layer outputs determined by the target device may also be referred to as “target device layer outputs”. For example, the system may provide the neural network to the target device. The target device may be configured to determine layer outputs of the layer(s) of the neural network using hardware components (e.g., processor(s), ADC(s), etc.) of the target device. The target device may be configured to determine layer outputs of the layer(s) by: (1) obtaining the sample inputs used by the training system; and (2) using parameters of the neural network to determine layer outputs of the layer(s). In some embodiments, the sample inputs may include inputs of hidden layers captured by introspection on the neural network. The hardware components of the target device may introduce quantization error into the computations of the layer outputs (e.g., due to a lower precision used to represent parameters of the neural network and/or noise from an ADC of the target device). The system performing process 500 may be configured to obtain the layer outputs determined by the target device by receiving them from the target device or another device that obtained the layer outputs from the target device. For example, the system may receive the layer outputs in a data transmission through a communication network (e.g., the Internet).

Next, process 500 proceeds to block 506, where the system determines a measure of difference between the training system layer outputs and the target device layer outputs. In some embodiments, the system may be configured to determine the measure of difference to be a difference calculated between the layer outputs and the target layer outputs. In some embodiments, the system may be configured to determine the measure of difference to be a measure of distance (e.g., Euclidean distance, Hamming distance, Manhattan distance, or other suitable distance measure) between the layer outputs. In some embodiments, the system may be configured to provide the training system layer outputs and target device layer outputs as input to a function. For example, the function may be a histogram function to generate, for each of the layer(s), a histogram of differences between the training system layer outputs and the target device layer outputs. As another example, the function may be a Gaussian distribution parameterized by a mean and standard deviation for each of the layer(s). In another example, the function may be a mixture of Gaussian distributions, to generate multimodal distributions, parameterized by multiple means and standard deviations for each of the layer(s). In another example, the function may be a generative adversarial network (GAN) trained to generate noise samples, or a conditional GAN trained to generate noise samples conditioned on the weights, inputs, and/or outputs of the neural network on the system and/or the target device.

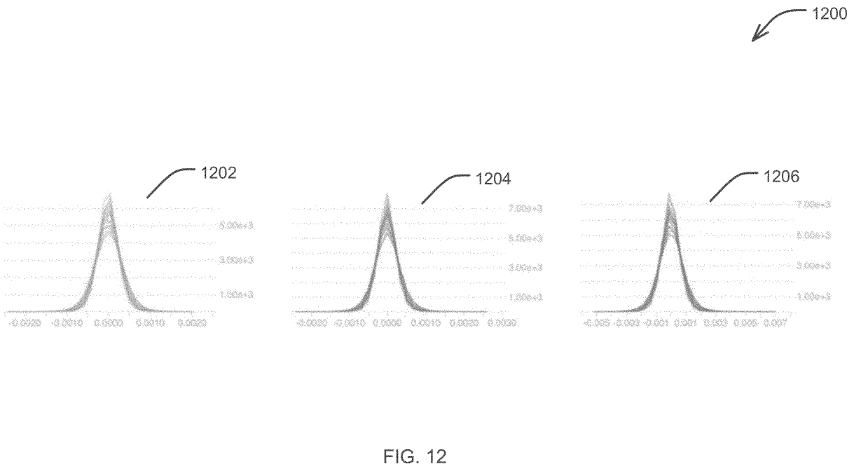

FIG. 12 illustrates an example set 1200 of histograms plotting differences between training system layer outputs and device layer outputs of a layer of a neural network for different batches of data, according to some embodiments of the technology described herein. Histogram 1202 plots differences for a first batch of data, histogram 1204 plots differences for a second batch of data, and histogram 1206 plots differences for a third batch of data. In some embodiments, for each batch of data, the system may generate a histogram for each layer of the neural network. In some embodiments, for each batch of data, the system may generate a single histogram of differences for all the layers of the neural network.

Next, process 500 proceeds to block 508, where the system generates a quantization noise model for the target device using the determined difference between the training system layer outputs and the target device layer outputs. In some embodiments, the quantization noise model may be a single quantization noise model used for the layers of the neural network. In some embodiments, the quantization noise model may include a respective noise model for each of the layer(s) of the neural network.

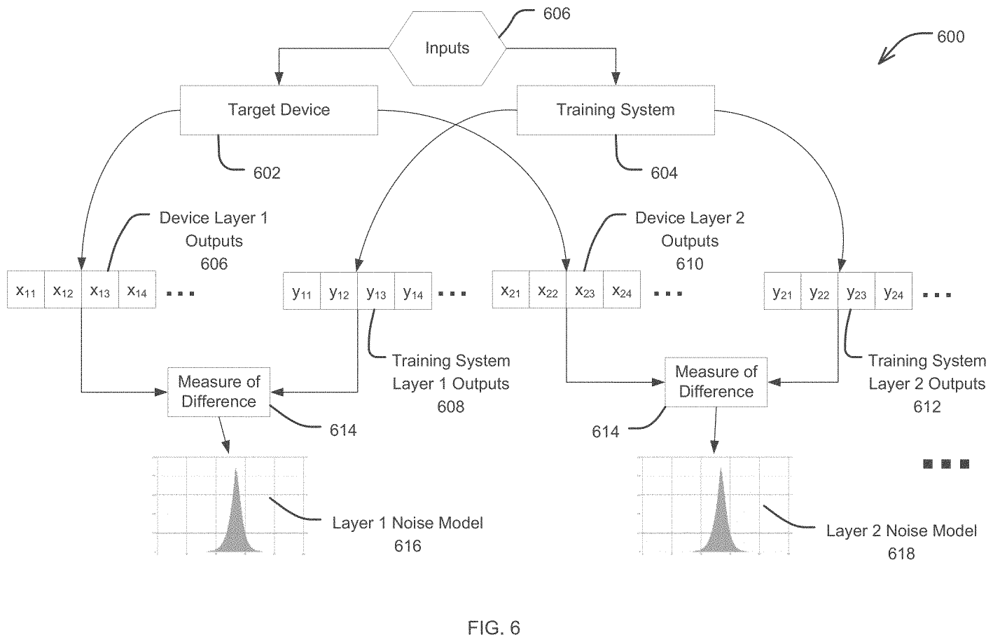

FIG. 6 illustrates diagram 600 depicting generation of a quantization noise model for a target device, according to some embodiments of the technology described herein. As shown in FIG. 6, sample inputs 606 are used by the target device 602 and training system 604 to determine layer outputs (e.g., as described at blocks 502 and 504). The target device layer outputs include layer 1 outputs 606 and layer 2 outputs 610. The training system layer outputs include layer 1 outputs 608 and layer 2 outputs 612. The system performing process 500 then uses a measure of difference 614 to generate a noise model for each layer. FIG. 6 shows a noise model 616 generated for layer 1 of the neural network and a noise model 618 for layer 2 of the neural network. It should be appreciated that although FIG. 6 depicts generation of noise models for two layers, some embodiments are not limited to any particular number layers.

The system may be configured to generate a noise model in various different ways. In some embodiments, the system may be configured to generate the noise model by determining parameters of a distribution that is used to model noise resulting from quantization error. For example, the system may determine parameters of a Gaussian distribution (e.g., mean or variance) that is to be used as the noise model. In another example, the system may determine parameters of a uniform distribution (e.g., minimum, and maximum value) that is to be used as the noise model. In some embodiments, the system may be configured to determine a histogram of difference values as the noise model. In some embodiments, the system may be configured to determine parameter(s) of a Gaussian mixture model, a GAN, or a conditional GAN as the noise model.

After generating the quantization noise model at block 508, the quantization noise model may be used to train a neural network (e.g., to be robust to quantization error on a target device). For example, the generated quantization noise model may be used by a training system to perform process 300 described herein with reference to FIG. 3.

FIG. 7 illustrates an example processor 70, according to some embodiments of the technology described herein. The processor 70 may be a processor of target device 104 described herein with reference to FIG. 1. The example processor 70 of FIG. 7 is a hybrid analog-digital processor implemented using photonic circuits. As shown in FIG. 7, the processor 70 includes a digital controller 700, digital-to-analog converter (DAC) modules 706, 708, an ADC module 710, and a photonic accelerator 750. Digital controller 700 operates in the digital domain and photonic accelerator 750 operates in the analog photonic domain. Digital controller 700 includes a digital processor 702 and memory 704. Photonic accelerator 750 includes an optical encoder module 752, an optical computation module 154, and an optical receiver module 756. DAC modules 106, 108 convert digital data to analog signals. ADC module 710 converts analog signals to digital values. Thus, the DAC/ADC modules provide an interface between the digital domain and the analog domain used by the processor 70. For example, DAC module 706 may produce N analog signals (one for each entry in an input vector), a DAC module 708 may produce N×N analog signals (e.g., one for each entry of a matrix storing neural network parameters), and ADC module 710 may receive N analog signals (e.g., one for each entry of an output vector).

The processor 70 may be configured to generate or receive (e.g., from an external device) an input vector of a set of input bit strings and output an output vector of a set of output bit strings. For example, if the input vector is an N-dimensional vector, the input vector may be represented by N bit strings, each bit string representing a respective component of the vector. An input bit string may be an electrical signal and an output bit string may be transmitted as an electrical signal (e.g., to an external device). In some embodiments, the digital process 702 does not necessarily output an output bit string after every process iteration. Instead, the digital processor 702 may use one or more output bit strings to determine a new input bit string to feed through the components of the processor 70. In some embodiments, the output bit string itself may be used as the input bit string for a subsequent process iteration. In some embodiments, multiple output bit streams are combined in various ways to determine a subsequent input bit string. For example, one or more output bit strings may be summed together as part of the determination of the subsequent input bit string.

DAC module 706 may be configured to convert the input bit strings into analog signals. The optical encoder module 752 may be configured to convert the analog signals into optically encoded information to be processed by the optical computation module 754. The information may be encoded in the amplitude, phase, and/or frequency of an optical pulse. Accordingly, optical encoder module 752 may include optical amplitude modulators, optical phase modulators and/or optical frequency modulators. In some embodiments, the optical signal represents the value and sign of the associated bit string as an amplitude and a phase of an optical pulse. In some embodiments, the phase may be limited to a binary choice of either a zero phase shift or a 71 phase shift, representing a positive and negative value, respectively. Some embodiments are not limited to real input vector values. Complex vector components may be represented by, for example, using more than two phase values when encoding the optical signal.

The optical encoder module 752 may be configured to output N separate optical pulses that are transmitted to the optical computation module 754. Each output of the optical encoder module 752 may be coupled one-to-one to an input of the optical computation module 754. In some embodiments, the optical encoder module 752 may be disposed on the same substrate as the optical computation module 754 (e.g., the optical encoder 752 and the optical computation module 754 are on the same chip). The optical signals may be transmitted from the optical encoder module 752 to the optical computation module 754 in waveguides, such as silicon photonic waveguides. In some embodiments, the optical encoder module 752 may be on a separate substrate from the optical computation module 754. The optical signals may be transmitted from the optical encoder module 752 to optical computation module 754 with optical fibers.

The optical computation module 754 may be configured to perform multiplication of an input vector ‘X’ by a matrix ‘A’. In some embodiments, the optical computation module 754 includes multiple optical multipliers each configured to perform a scalar multiplication between an entry of the input vector and an entry of matrix ‘A’ in the optical domain. Optionally, optical computation module 754 may further include optical adders for adding the results of the scalar multiplications to one another in the optical domain. In some embodiments, the additions may be performed electrically. For example, optical receiver module 756 may produce a voltage resulting from the integration (over time) of a photocurrent received from a photodetector.

The optical computation module 754 may be configured to output N optical pulses that are transmitted to the optical receiver module 756. Each output of the optical computation module 754 is coupled one-to-one to an input of the optical receiver module 756. In some embodiments, the optical computation module 754 may be on the same substrate as the optical receiver module 756 (e.g., the optical computation module 754 and the optical receiver module 756 are on the same chip). The optical signals may be transmitted from the optical computation module 754 to the optical receiver module 756 in silicon photonic waveguides. In some embodiments, the optical computation module 754 may be disposed on a separate substrate from the optical receiver module 756. The optical signals may be transmitted from the optical computation module 754 to the optical receiver module 756 using optical fibers.

The optical receiver module 756 may be configured to receive the N optical pulses from the optical computation module 754. Each of the optical pulses may be converted to an electrical analog signal. In some embodiments, the intensity and phase of each of the optical pulses may be detected by optical detectors within the optical receiver module. The electrical signals representing those measured values may then be converted into the digital domain using ADC module 710, and provided back to the digital process 702.

The digital processor 702 may be configured to control the optical encoder module 752, the optical computation module 754 and the optical receiver module 756. The memory 704 may be configured to store input and output bit strings and measurement results from the optical receiver module 756. The memory 704 also stores executable instructions that, when executed by the digital processor 702, control the optical encoder module 752, optical computation module 754, and optical receiver module 756. The memory 704 may also include executable instructions that cause the digital processor 702 to determine a new input vector to send to the optical encoder based on a collection of one or more output vectors determined by the measurement performed by the optical receiver module 756. In this way, the digital processor 702 may be configured to control an iterative process by which an input vector is multiplied by multiple matrices by adjusting the settings of the optical computation module 754 and feeding detection information from the optical receive module 756 back to the optical encoder 752. Thus, the output vector transmitted by the processor 70 to an external device may be the result of multiple matrix multiplications, not simply a single matrix multiplication.

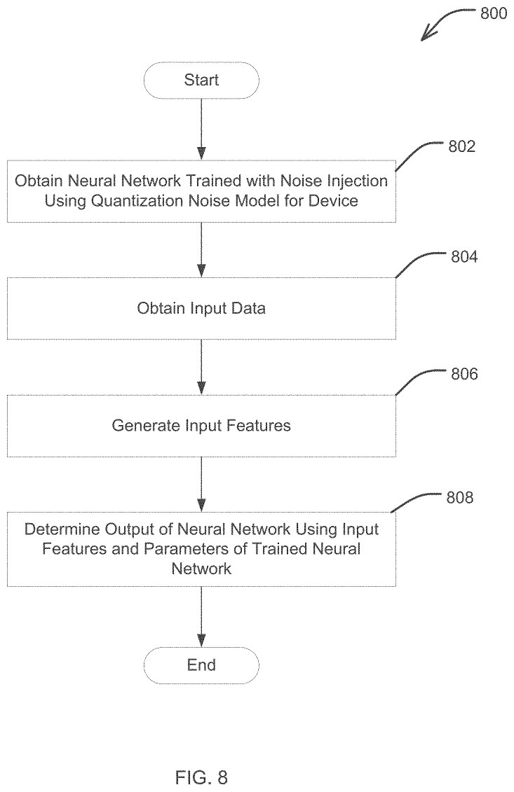

FIG. 8 illustrates an example process 800 for determining an output of a neural network by a device, according to some embodiments of the technology described herein. Process 800 may be performed by any suitable computing device. For example, process 800 may be performed by target device 104 described herein with reference to FIG. 1. The target device may perform process 800 using processor 70 described herein with reference to FIG. 7.

Process 800 begins at block 802, where the device obtains a neural network trained with noise injection using a quantization noise model for the device. For example, the device may obtain a neural network trained using process 300 described herein with reference to FIG. 3. The quantization noise model may be obtained using process 600 described herein with reference to FIG. 6. The device may be configured to obtain the neural network by obtaining trained parameters (e.g., weights) of the neural network. For example, the device may receive the parameters through a communication network (e.g., from training system 102). The device may be configured to store the trained parameters in memory of the device.

Next, process 800 proceeds to block 804, where the device obtains input data. The device may be configured to receive input data from another system. For example, the device may receive input data from a computing device through a communication network (e.g., the Internet). In another example, the device may be a component of a system with multiple components, and receive the input data from another component of the system. In another example, the device may generate the input data. As an illustrative example, the input data may be an image captured by a camera of the device that is to be processed (e.g., enhanced) using the neural network.

Next, process 800 proceeds to block 806, where the system generates a set of input features. The device may be configured to process the input data to generate a set of input features that can be used as input to the neural network. For example, the device may encode parameters of the input data, normalize parameters of the input data, or perform other processing. In some embodiments, the device may be configured to organize parameters into a data structure (e.g., vector, array, matrix, tensor, or other type of data structure) to use as input to the neural network. For example, the device may generate a vector of input features. In another example, the device may generate a matrix of input features.

Next, process 800 proceeds to block 808, where the device determines an output of the neural network using the input features and the parameters of the neural network. The device may be configured to compute the output using the input features and the parameters of the neural network. The device may be configured to determine a sequence of layer outputs and an output of the neural network using the layer outputs. For example, the device may determine layer outputs of convolutional layers using convolution kernels and/or outputs of fully connected layers using weights associated with nodes. The device may be configured to use the layer outputs to determine an output of the neural network. For example, the output of the neural network may be a classification, a predicted likelihood, or pixel values of an enhanced image.

In some embodiments, the device may be configured to determine a layer output for a layer by performing computations using matrices. An input to the layer (e.g., a layer output of a previous layer or a sample input) may be organized into a matrix. The parameters (e.g., weights and/or biases) of the layer may be organized into a matrix. The device may be configured to determine the layer output by performing matrix multiplication between the input matrix and the parameters matrix to generate an output matrix. For example, the output matrix may store the output of each node of the layer in a row or column of the output matrix. FIG. 9A described above illustrates an example matrix multiplication operation that is to be performed to determine a layer output.

In some embodiments, the device may be configured to determine a layer output matrix using an input matrix and a parameter matrix using tiling. Tiling may divide a matrix operation into multiple operations between smaller matrices. The device may be configured to use tiling to perform the multiplication operation in multiple passes. In each pass, the device may perform an operation over a tile of a matrix. Tiling may allow the target device to perform matrix operations using a smaller processor. An example of tiling is described herein with reference to FIG. 9B.

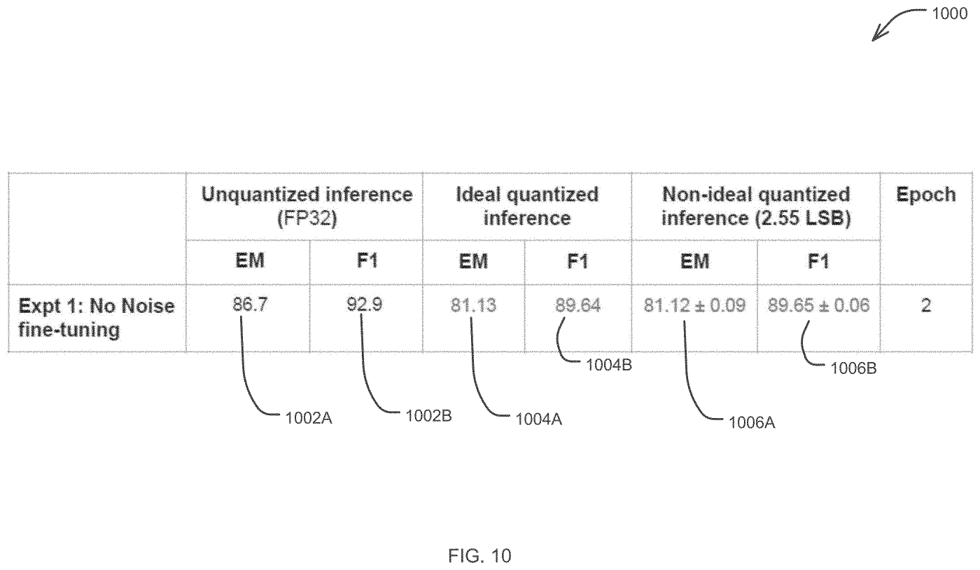

FIG. 10 illustrates a table 1000 indicating performance of a neural network on a target device relative to a training system where the neural network was trained without noise injection using a quantization noise model for the target device. The table 1000 indicates an expectation match (EM) value 1002A of 86.7, and an F1 score 1002B of 92.9 for unquantized inference of the neural network using a 32-bit floating point format to represent parameters (e.g., inference performed on the training system). The table 1000 indicates an EM value 1004A of 81.13, and an F1 score 1004B of 89.64 for ideal quantized inference (i.e., quantization without noise). The table 1000 indicates an EM value 1006A of 81.12±0.09 and an F1 score 1006B of 89.65±0.06 for non-ideal quantized inference (i.e., quantization with noise).

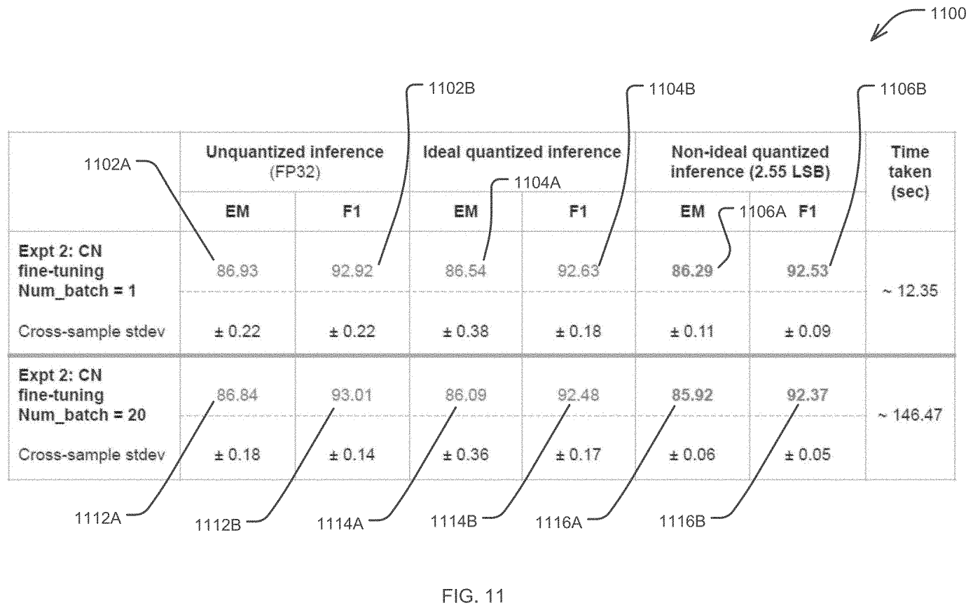

FIG. 11 illustrates a table 1100 indicating performance of a neural network on a target device relative to a training system where the neural network was trained with noise injection using a quantization noise model for the target device, according to some embodiments of the technology described herein. Table 1100 indicates performance of the neural network when trained using 1 training data batch, and performance of the neural network when trained using 20 training batches. In the case of 1 training batch, the table 1100 indicates: (1) an EM value 1102A of 86.93 and an F1 score 1102B of 92.92 for unquantized inference using a 32-bit floating format to represent numbers; (2) an EM value 1104A of 86.54 and an F1 score 1104B of 92.63 for ideal quantized inference; and (3) an EM value 1106A of 86.29 and an F1 score 1106B of 92.53 for non-ideal quantized inference. In the case of 20 training batches, the table 1100 indicates: (1) an EM value 1112A of 86.84 and an F1 score 1112B of 93.01 for unquantized inference; (2) an EM value 1114A of 86.09 and an F1 score 1114B of 86.09 for ideal quantized inference; and (3) an EM value 1116A of 85.92 and an F1 score 1116B of 92.37 for non-ideal quantized inference. As can be appreciated from the EM values and F1 scores indicated by table 1000 of FIG. 10, and table 1100 of FIG. 11, the performance of the neural networks trained with noise injection using a quantization noise model for the target device is better than that of the neural network trained without the noise injection. Moreover, the neural networks trained with noise injection using a quantization noise model for the target device are able to achieve 99% EM (85.53) and 99% F1 score (91.97) of the unquantized inference.

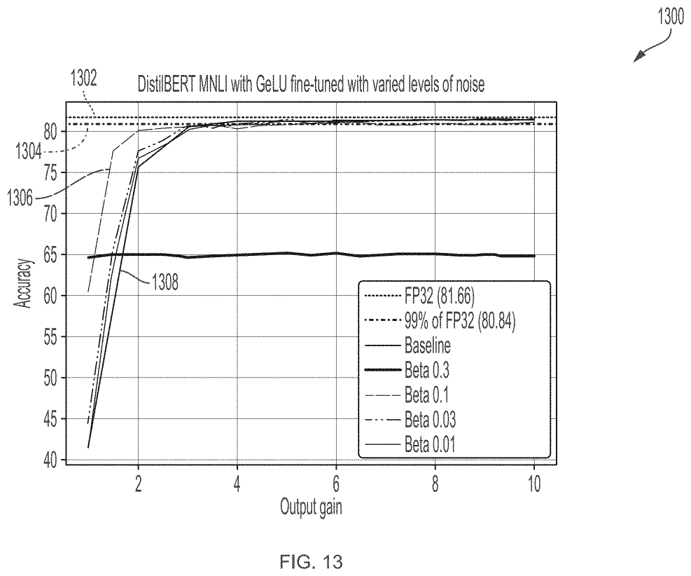

FIG. 13 illustrates a graph 1300 depicting performance of example neural networks on a device relative to a training system, according to some embodiments of the technology described herein. Graph 1300 plots accuracy of the DistilBERT natural language processing neural network relative to an output gain of an analog processor and an ADC of the device. In some embodiments, the output gain may be a scalar quantity that identifies the power of an optical source (e.g., a laser). Increasing the power may result in a stronger signal (e.g., a larger output value) at an analog-to-digital converter (ADC) of the device. Thus, a greater power may provide a higher signal-to-noise ratio in values output by the ADC of the device. Line 1302 in the graph 1300 indicates unquantized inference accuracy of the neural network on a training system processor that uses a 32-bit floating point representation for parameters of the neural network. Line 1304 indicates 99% of the unquantized inference accuracy. The graph 1300 plots accuracy vs. output gain on the device for different levels of noise used to train the neural network. For example, line 1306 indicates accuracy vs. output gain of a neural network on the device with a scalar value of 0.1 applied to quantization noise model parameter(s) (e.g., variance). Line 1308 indicates accuracy vs. output gain for a scalar value of 1.0 (i.e., non-scaled noise) applied to quantization noise model parameter(s). As can be appreciated from FIG. 13, the neural networks trained using a quantization noise model achieve 99% of unquantized inference accuracy for an output gain of less than 3.

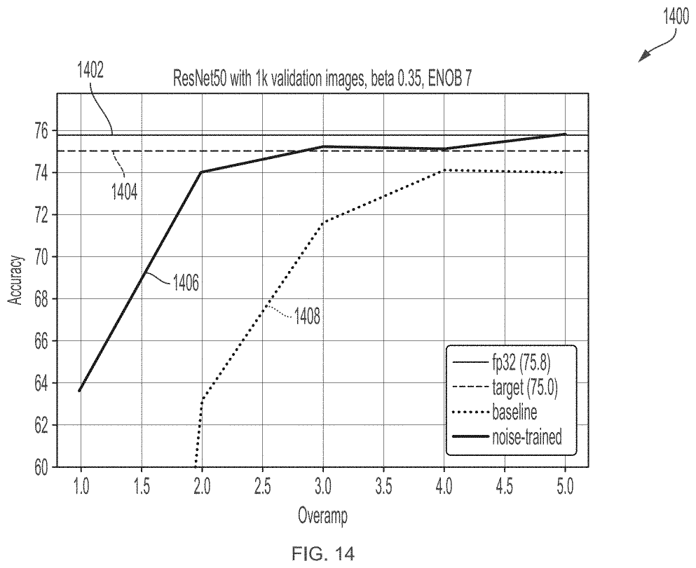

FIG. 14 illustrates a graph 1400 depicting performance of an example neural network on a device relative to a training system, according to some embodiments of the technology described herein. Graph 1400 plots accuracy of the ResNet50 neural network relative to an output gain of an analog processor and an ADC of the device. Line 1402 indicates accuracy of the neural network on a training system that uses 32-bit floating point representation for parameters of the neural network (i.e., unquantized accuracy). Line 1404 indicates 99% of the unquantized accuracy. Line 1408 indicates accuracy of the neural network on the device when trained without noise injection. Line 1406 indicates accuracy of the neural network on the device when trained with noise injection using a quantization noise model of the device (e.g., by performing process 300 described with reference to FIG. 3). As can be appreciated from FIG. 14, the neural network trained with noise injection using a quantization noise model for the device achieves greater accuracy for each output gain than the neural network trained without noise injection. The noise-trained neural network achieves 75% accuracy at an output gain of 3, which meets the 99% of unquantized accuracy threshold. The neural network trained without noise injection achieves less than 72% accuracy at an output gain of 3, and never attains 99% of the unquantized inference accuracy.

FIG. 15 shows a block diagram of an example computer system 1500 that may be used to implement some embodiments of the technology described herein. The computing device 1500 may include one or more computer hardware processors 1502 and non-transitory computer-readable storage media (e.g., memory 1504 and one or more non-volatile storage devices 1506). The processor(s) 1502 may control writing data to and reading data from (1) the memory 1504; and (2) the non-volatile storage device(s) 1506. To perform any of the functionality described herein, the processor(s) 1502 may execute one or more processor-executable instructions stored in one or more non-transitory computer-readable storage media (e.g., the memory 1504), which may serve as non-transitory computer-readable storage media storing processor-executable instructions for execution by the processor(s) 1502.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of training a neural network for use on a device, the neural network comprising a plurality of layers and a plurality of parameters, the method comprising:
using a processor to perform:
obtaining training data comprising a plurality of sample inputs;
training the neural network using the training data, the training comprising, for each of at least some of the plurality of sample inputs:
determining, using the sample input, a layer output of at least one layer of the plurality of layers of the neural network;
obtaining a noise sample from a quantization noise model for the device;
injecting the noise sample into the layer output;
determining an output of the neural network for the sample input using the layer output injected with the noise sample; and
updating the plurality of parameters of the neural network using the output.

2. The method of claim 1, wherein the at least one layer of the neural network comprises at least one hidden layer of the neural network.

3. The method of claim 1, wherein the processor uses a first bit width, and the device uses a second bit width, wherein the first bit width is greater than the second bit width.

4. The method of claim 3, wherein the first bit-width is at least 32 bits.

5. The method of claim 3, wherein the second bit-width is less than 16 bits.

6. The method of claim 1, wherein the device comprises an optical processor.

7. The method of claim 1, wherein the layer output comprises a plurality of values and obtaining the noise sample comprises obtaining a noise sample value for each of the plurality of values.

8. The method of claim 1, wherein injecting the noise sample into the layer output comprises additively injecting the noise sample into the layer output.

9. The method of claim 1, wherein injecting the noise sample into the layer output comprises multiplicatively injecting the noise sample into the layer output.

10. The method of claim 1, wherein the quantization noise model comprises a Gaussian noise model.

11. The method of claim 1, wherein the quantization noise model is determined based on a difference between:
layer outputs of one or more layers of a previously trained neural network determined by the processor for a set of inputs; and
layer outputs of the one or more layers of the previously trained neural network determined by the device for the set of inputs.

12. The method of claim 1, further comprising generating the quantization noise model for the device.

13. The method of claim 12, wherein generating the quantization noise model for the device comprises:
determining, for a set of inputs using the processor, layer outputs of one or more layers of a previously trained neural network;
obtaining, for the set inputs, layer outputs of one or more layers of the previously trained neural network determined by the device;
determining a difference between the layer outputs determined using the processor and the layer outputs determined by the device; and
generating the quantization noise model for the device using the difference.

14. The method of claim 1, wherein the quantization noise model for the device comprises a parameter and a scalar applied to the parameter, and training the neural network comprises:
after determining a first output of the neural network for a first one of the at least some sample inputs, increasing the scalar applied to the parameter; and
determining a second output of the neural network for a second one of the at least some sample inputs using the quantization noise model with the increased scalar applied to the parameter.

15. The method of claim 1, wherein the plurality of sample inputs comprises a first plurality of sample inputs and a second plurality of sample inputs that is a duplicate of the first plurality of sample inputs;
wherein the at least some sample inputs consist of sample inputs from only one of the first plurality of sample inputs and the second plurality of sample inputs.

16. The method of claim 15, wherein obtaining the plurality of sample inputs comprises:
obtaining the first plurality of sample inputs; and
duplicating the first plurality of sample inputs to obtain the second plurality of sample inputs.

17. The method of claim 1, wherein the neural network is a previously trained neural network.

18. The method of claim 1, wherein the neural network is an untrained neural network.

19. A system for training a neural network for use on a device separate from the system, the neural network comprising a plurality of layers and a plurality of parameters, the system comprising:
a processor; and
a non-transitory computer-readable storage medium storing instructions that, when executed by the processor, cause the processor to:
obtain training data comprising a plurality of sample inputs;
train the neural network using the training data, the training comprising, for each of at least some of the plurality of sample inputs:
determining, using the sample input, a layer output of at least one layer of the plurality of layers of the neural network;
obtaining a noise sample from a quantization noise model for the device;
injecting the noise sample into the layer output;
determining an output of the neural network for the sample input using the layer output injected with the noise sample; and
updating the plurality of parameters of the neural network using the output.

20. A non-transitory computer-readable medium storing instructions that, when executed by a processor, cause the processor to perform:
obtaining training data comprising a plurality of sample inputs;
training a neural network using training data, the neural network comprising a plurality of layers and a plurality of parameters, the training comprising, for each of at least some of the plurality of sample inputs:
determining, using the sample input, a layer output of at least one layer of the plurality of layers of the neural network;
obtaining a noise sample from a quantization noise model for the device;
injecting the noise sample into the layer output;
determining an output of the neural network for the sample input using the layer output injected with the noise sample; and
updating the plurality of parameters of the neural network using the output.

21. A device comprising:
at least one processor; and
a non-transitory computer-readable storage medium storing:
a plurality of parameters of a trained neural network, the trained neural network obtained by training a neural network using a quantization noise model for the device; and
instructions that, when executed by the at least one processor, cause the at least one processor to:
obtain input data;
generate, using the input data, a set of input features for the trained neural network; and
determining an output of the trained neural network for the set of input features using the plurality parameters of the trained neural network.

22. The device of claim 21, wherein the at least one processor uses a first bit width, and the trained neural network was trained using a processor that uses a second bit width, wherein the first bit width is less than the second bit width.

23. The device of claim 21, wherein the at least one processor includes an analog processor.

24. The device of claim 21, wherein the at least one processor includes an optical processor.
